(19) United States
(12) Patent Application Publication
(10) Pub. No.: US 2009/0292642 A1
(43) Pub. Date: Nov. 26, 2009

(54) Method and system for automatically issuing digital merchant based online payment card

(76) Inventor: Yanchou Han, Naperville, IL (US)

Correspondence Address: CARDINAL LAW GROUP, LLC, SUITE 2000, 1603 ORRINGTON AVENUE, EVANSTON, IL, 60201, US

(21) Appl. No.: 12/295,698

(22) PCT Filed: Jul. 6, 2006
(86) PCT No.: PCT/US06/26267

§ 371 Date: Oct. 1, 2008

Related U.S. Application Data
(60) Provisional application No. 60/696,736, filed on Jul. 6, 2005.

(51) Int. Cl. G06Q 20/00; H04L 9/32

(52) U.S. Cl. 705/71; 705/35

(57) ABSTRACT

An online payment card is a digital form card derived from a credit/debit card or bank account of a customer. A central service provider issues the online payment card electronically to a registered merchant system under the authorization of the owner of the ordinary credhVdebit or bank account. The central service provider maintains the association of the online payment card with the ordinary credit/debit card or bank account of the customer, and the identity of the merchant that the payment is issued to. The merchant handles the online payment card in the same manner as ordinary card. When the merchant submits a request for authorization, the central service provider verifies if the online payment card is associated with the merchant who submits the authorization request. If the verification successes, the central service provider process the authorization request using the ordinary credit/debit which is associated with the online payment card.

### RELATED APPLICATIONS

This application claims priority to U.S. Provisional Patent Application 60/696,736 filed Jul. 6, 2005, the entirety of which is hereby incorporated by reference.

### FIELD OF THE INVENTION

This invention relates generally to payments. More specifically, the invention relates to processing payments online.

### BACKGROUND OF THE INVENTION

Many people become nervous about transacting business over the Internet, especially with a credit card. Merchants desiring to transact business benefit by removing or reducing such fear.

Prior solutions are unsatisfactory as either insufficient, or insufficiently scalable.

Therefore, it would be desirable to provide a method and system that overcomes the aforementioned and other disadvantages.

### SUMMARY OF THE INVENTION

One aspect of the invention provides a method for facilitating online commerce. The method includes receiving a payment request at a credit facility, and sending a payment identifier to a merchant based on the payment request.

A second aspect of the invention provides a method for facilitating online commerce. The method includes receiving a request to pay at a merchant server from a customer and sending a payment request to a credit facility from the merchant server. The method further includes redirecting the customer to the credit facility based on the sending of the payment request and receiving a payment identifier at the merchant server from the credit facility.

Another aspect of the invention provides a method for facilitating online commerce. The method includes receiving a request to pay at the merchant from the customer and sending the customer a payment request based on the request to pay, the payment request including a merchant ID and a digital signature associated with the merchant. The method further includes redirecting the customer to a credit facility, receiving a payment identifier from the customer, and transmitting the payment identifier to the credit facility.

The aforementioned, and other features and advantages of the invention will become further apparent from the following detailed description of the presently preferred embodiments, read in conjunction with the accompanying drawings. The detailed description and drawings, which are not to scale, are merely illustrative of the invention rather than limiting, the scope of the invention being defined by the appended claims and equivalents thereof.

### BRIEF DESCRIPTION OF THE DRAWINGS

FIG. 1 shows an online payment system for conducting online commerce transactions, in accordance with one aspect of the present invention;

FIG. 2 shows the significant software component diagram of the central service provider, merchant system and customer computer, in accordance with one aspect of the present invention;

FIG. 3 shows the significant software component diagram of the central service provider, merchant system and customer computer, in accordance with one aspect of the present invention;

FIG. 4 shows the online commerce system during a payment authorization phase in accordance with one aspect of the invention;

FIG. 5 illustrates one embodiment of a method for facilitating online commerce in accordance with one aspect of the invention;

FIG. 6 illustrates one embodiment of a method for redirecting a customer in accordance with one aspect of the invention;

FIG. 7 illustrates one embodiment of a method for redirecting a customer in accordance with one aspect of the invention;

FIG. 8 illustrates one embodiment of a method for facilitating online commerce in accordance with one aspect of the invention;

FIG. 9 illustrates one embodiment of a method for facilitating online commerce in accordance with one aspect of the invention;

FIG. 10 illustrates one embodiment of a method for issuing payment in accordance with one aspect of the invention; and

FIG. 11 illustrates one embodiment of a method for issuing payment in accordance with one aspect of the invention.

### DETAILED DESCRIPTION OF THE DRAWINGS

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein

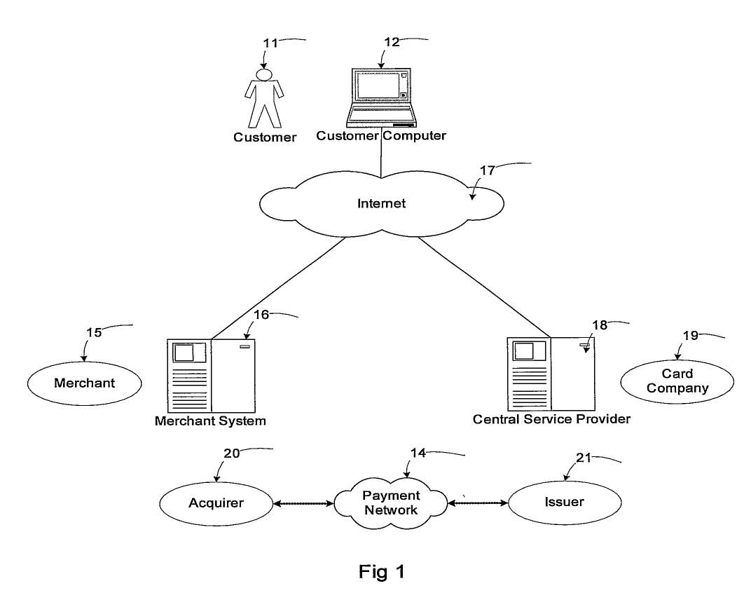

FIG. 1 shows an online payment system for conducting online commerce transactions. For general discussion purposes, three participants to an online commerce transaction are shown: a customer 11, a merchant 15, and a card company 19. These three participants play the primary roles in the online commerce transaction. The customer and merchant may represent individual people, entities, or businesses. Card Company 19 may represent an independent online payment company, bank issuers, or other types of card-issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing system to facilitate online commerce transactions. The customer 11 has a computing unit 12 in the form of a personal computer, although other types of computing units may be used including laptops, notebooks, handheld computers, set-top boxes, PDA, Internet TV, mobile phone and the like. The merchant 15 has a computing unit 16 implemented in the form of a computer server, although other implementations are possible. The card company 19 has a computing center which may be implemented in any forms, such as a minicomputer, a PC server, a networked set of computers, mainframe and the like. The software package, central services provider, is hosted in card company computer center.

The computing units 12, 16, and 18 are connected with each other via a data communication network 17. The network 17 is a public network and assumed to be insecure and open to eavesdroppers. In the illustrated implementation, the network is embodied as the Internet. In this context, the computers may or may not be connected to the Internet 17 at all times. For instance, the customer computer 12 may employ a modem to occasionally connect to the Internet 17, whereas the card company computing center 18 might maintain a permanent connection to the Internet 17. It is noted that the network 17 may be implemented as other types of networks, such as an interactive television (ITV) network.

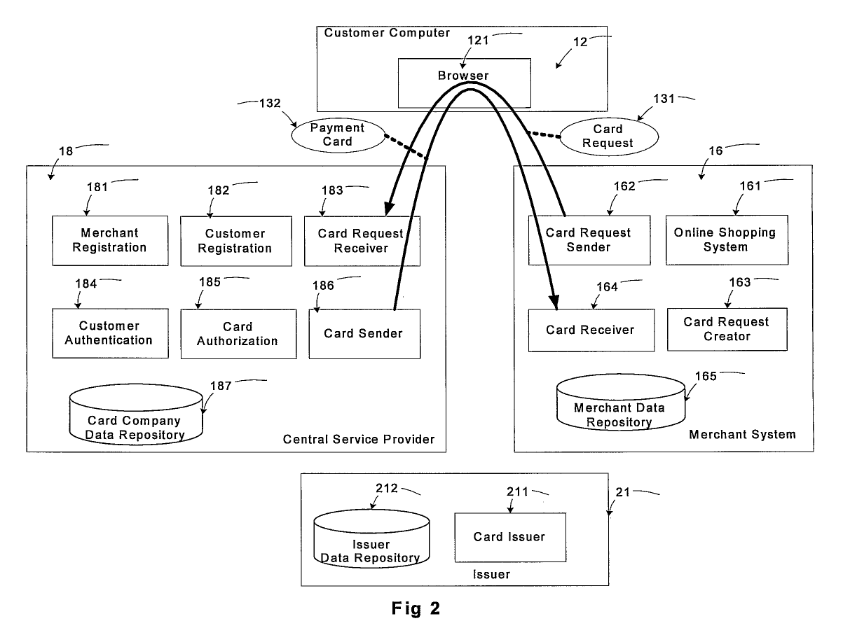

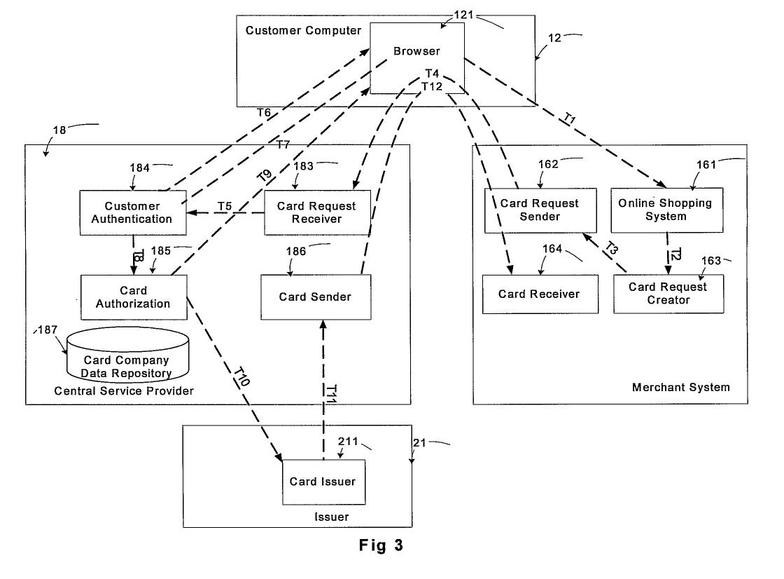

FIG. 2 shows the significant software component diagram of the central service provider 18, merchant system 16 and customer computer 12.

Browser 121 is a program running inside customer computer 12. Browser is able to connect to public network and display the content of merchant system and the central service provider.

Operation

There are four distinct phases supported by the online commerce system: a merchant registration phase, a customer registration phase, a transaction phase, and a payment authorization phase.

Concept of Online Payment Card

The “online payment card” does not exist in physical form, but in digital form card which is derived from an ordinary credit/debit card or bank account of an online customer. The Central Service Provider 18 issues the online Payment card to the merchant 16 directly under the authorization of customer 11. For secure purpose, the issued card could be optionally signed with digital certificate binding to the Central Service provider 18 and encrypted with digital certificate binding to merchant 16. The customer 11 authorizes the card issuing but not necessarily holds the card. The central service provider 18 maintains the association of the online payment card with the ordinary credit/debit card or bank account of the customer, and the identity of the merchant that the online payment is issued to. The Central Service Provider 18 and the merchant 16 software modules can be invoked when using the online payment card to conduct a transaction on the Internet 17. The payment card is used only on the specific merchant and not any other merchant, therefore the said online payment card is referred as Merchant Based Card (MBC). Depends on the business agreement between the Central Service Provider 18 and the merchant 16, the Payment card can be configured to be used for only one transaction. In this case, the said MBC card is also referred as Merchant Transaction Based Card (MTBC).

Merchant Registration Phase

The merchant 15 registers to the Central Service Provider 18 with some merchant information such as merchant name, online application URLs, address and the merchant public digital certificate etc. The Central Service Provider 18 creates an online account to the merchant 16. The merchant account profile is retained in a data repository at the Central Service Provider 18. The merchant registration guarantees that only trusted merchant can participate the transactions descript in this patent. Based on the merchant profile, the Central Services Provider 18 has capability to assure that any issued electronic online Payment card is only validated for specific merchant.

### Customer Registration Phase

The customer 11 registers to the Central Service Provider 18 with an ordinary credit/debit card or a bank account. The Central Services provider 18 validates the information provided by customer 11 and then creates an online account for the Customer 11. The customer account profile is retained in a data repository at the Central Services Provider 18. The customer can use the created account to authorize the Central Services Provider 18 issuing an electronic “online Payment card” to a specific merchant which already registered with the Central Service Provider 18.

Transaction Phase

T1: The customer 11 initiates an online payment by submitting a “check out” request to the Online Shopping Module 161. Optionally, the customer 11 can indicate what type payment methods used. For example, if customer 11 indicated using visa, master, American express, discover MBC card, the following transactions will be initiated.

T2: The Online Shopping Module 161 calculates the total amount and then forwards customer 11's request to the Card Request Creator 163.

T3: The Card Request Creator 163 creates a “Payment Card Request”. The “Payment Card Request” includes merchant and transaction information, for example merchant ID, unique transaction ID, time stamp, and the amount of transaction and other information. The created “Payment Card Request” is sent to Card Request Sender 162. For security purpose, the “Payment Card Request” should include an expiration time stamp to prevent malicious users from intercepting the “Payment Card Request” for further attacking.

T4: If there is a direct network channel between Merchant System 16 and Central Service Provider 18, the Card Request Sender 162 can send the “Payment Card Request” to Card Request Receiver 183 directly, and then redirect browser 121 connection from merchant 16 to Central Service Provider 18. If there is not direct network channel between Merchant System 16 and Central Service Provider 18, the Card Request Sender 162 can redirect the “Payment Card Request” to Card Request Receiver 183. In this case, it is highly recommended to have the “Payment Card Request” signed by Card Request Sender 162.

T5: Upon receiving the “Payment Card Request”, The Card Request Receiver 183 first needs to verify that the Payment Card Request is a validated request from a trusted merchant system and not expired. If the verification successes, the Card Request Receiver 183 sends the “Payment Card Request” to Customer Authentication 184.

T6: The customer Authentication 184 then prompts Customer 11 for authentication. If the Customer 11 has not registered with Central Service Provider 18 yet, Customer 11 should follow Customer Registration Process above to register herself to create an account.

T7: Customer 11 provides credentials to Customer Authentication 184.

T8: If the customer 11 is successfully authenticated, The Card Authorization 185 retrievals Merchant information from the Data Repository 187.

T9: Card Authorization 185 displays user with merchant information, possible transaction detail on merchant 16. Card Authorization 185 should also provide method for Customer 11 to allow or disallow Central Service Provider 18 to create an Online Payment Card for specified Merchant 16. Optionally, Card Authorization 185 should also provide method for Customer 11 to indicate the expiration date, limit of transaction amount.

T10: If Customer 11 authorizes Central Service Provider 18 to create a digital online payment card for the specific merchant 16, the Central service Provider 18 delegates the task to the Card Issuer 121. The Card Issuer 121 is a software component which may reside in Central Service Provider 18, Card Company 19, a bank or a card issuer. Card Issuer creates an online payment card. The online payment card has the same name and address with the Ordinary Card that the Customer 11 used to register at customer registration phase. The expiration date is as customer 11 indicated at T9. The card number different from the Ordinary Card but bears the same format. Optionally, the newly created online payment card is a lower limit amount than that ordinary card. The Card Issuer 211 retains the online payment card information in the data repository and maintains the relationship of online payment card with Ordinary Card.

T11: The Card Issuer then sends the Online Payment Card to Card Sender 186. Card Sender 186 can optionally sign and encrypt the online payment card.

T12: If there is a direct network channel between Merchant System 16 and Central Service Provider 18, the Card Sender 186 can send the “online payment card” to Card Receiver 164 directly, and then redirects browser 121 connection from Central Service Provider 18 to merchant 16. If there is not direct network channel between Merchant System 16 and Central Service Provider 18, the Card Request Sender 162 can redirect the online Payment Card to Card Receiver 164. In this case, it is highly recommended to have the “Payment Card” signed and encrypted by Card Sender 186.

Upon receiving the digital payment card, the Merchant System continues customer 11 payment process as ordinary process.

Authorization Phase

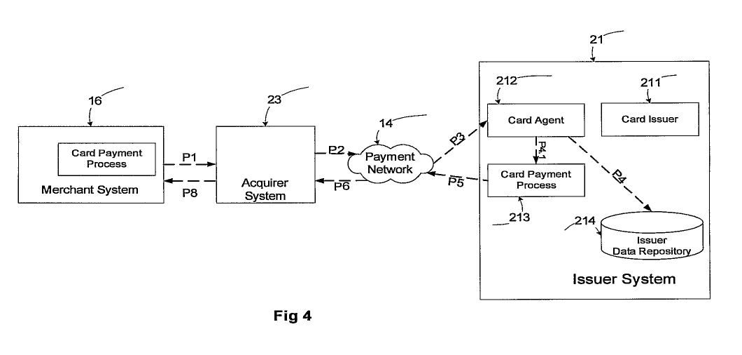

FIG. 4 shows the online commerce system during a payment authorization phase. This phase involves the merchant 15 seeking authorization from the issuing bank 22 to honor the customer's transaction number received by the merchant in the commerce transaction with the customer. The information exchange between the merchant computer 16, Acquirer Bank System 23, and the Issuer System 21 during the authorization phase are illustrated as enumerated lines.

The merchant 16 receives online payment card from the Internet and processes the online payment card number using its existing computer system. The merchant computer 16 treats the online payment number of the online payment card no differently than it treats a standard credit card number. In fact, the merchant computer 16 most likely will not be able to distinguish between the two types of numbers.

P1: The merchant system 16 submits a request for authorization to Acquirer bank system 23 for authorization.

P2 and P3: The acquiring bank validates the authorization request by verifying that the merchant is a valid merchant and that the credit card number represents a valid number. The acquirer bank system 23 submits the request to Card Agent 212 in Issuer System 21.

P4: The card Agent 212 checks with Issuer Data Repository 214 and check if the card is ordinary card or online payment card. If it is ordinary card, the card Agent just forwards the request to regular card payment process 213. If the card is digital online payment card created by the card Issuer 211, card agent will check if the merchant ID from authorization request matches the merchant ID which associated with the online payment card. If the merchant ID does not match, the card Agent notifies Card Payment Process 213 to refuse the authorization. If the merchant ID matches, the Card Agent 212 then check expiration data and transaction amount limitation. If verification success, the Card Agent 212 will retrieve the ordinary card number that the online payment card derived from and pass the ordinary card number to Card Payment Process.

P4.1: The Card Payment Process is ordinary card payment process that do the authorization works.

P5, P6: If the authorization is granted by Card Payment Process, a authorization response is returned to merchant System and the transaction is clean.

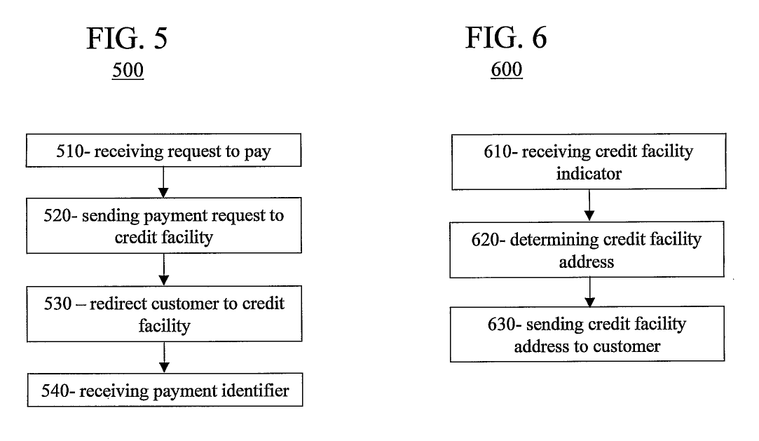

FIG. 5 illustrates one embodiment of a method 500 for facilitating online payment in accordance with one aspect of the invention. Method 500 begins at 510 by receiving a request to pay at a merchant server from a customer. The request to pay is received via an online connection, such as over a network. The network can be any network, including local area, wide area, the Internet or an intranet. For example, the network can be implemented as Internet 17. In one embodiment, the request is associated with at least one good or service offered by the merchant. For example, the payment request can be associated with the contents of an online shopping cart. The merchant server is any server or collection of servers operated by a merchant, or under control of the merchant for facilitating online commerce. In one example, the merchant server operates an online shopping cart. In one embodiment, the merchant server is implemented as in merchant system 16. The customer can be customer 11 and access the merchant server via customer computer 12.

Method 500 continues at 520 by sending a payment request to a credit facility from the merchant server. The credit facility is any third party serving to transfer money between parties to a transaction. For example, the credit facility can be a bank, credit card company, factor, debit issuing entity or the like.

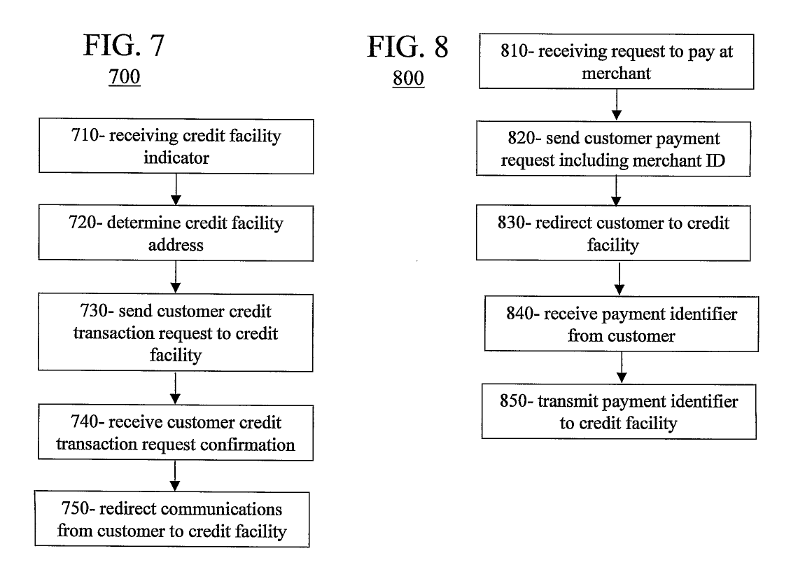

Method 500 continues at step 530 by redirecting the customer to a credit facility. Methods for redirecting the customer are outlined in FIGS. 6 and 7. The credit facility is any entity that provides a conduit for payments between a customer and the merchant, such as via a credit card, loan, cash advance, or other similar payment mechanisms. Alternatively, the credit facility can be a cash conduit, such as via a bank transaction associated with a depository account such as a checking, savings, or money market account. Other payment conduits are anticipated and the invention can be used with other such credit facilities. In one embodiment, the credit facility is implemented as in central service provider 18 offered by card company 19.

The merchant server receives a payment identifier at step 540. The payment identifier is data indicative of authority to receive payment. For example, the payment identifier can be a credit card number, a one-time use credit card number, account number or the like. In one embodiment, the payment identifier includes at least one association with at least one merchant. The association can be maintained in the credit facility database.

After receiving the payment identifier, the merchant server forwards the received payment identifier to the credit facility, in one embodiment. Forwarding the received payment identifier serves as a request for payment from the credit facility on behalf of the customer.

After forwarding the payment identifier to the credit facility, the merchant server receives payment from the credit facility based on the payment identifier, in one embodiment. The payment can take the form of an account transfer, funds transfer, or any other acceptable form of payment.

FIG. 6 illustrates one embodiment of a method 600 for redirecting a customer to a credit facility in accordance with one aspect of the invention. Method 600 begins at 610 by receiving a credit facility indicator at the merchant server. A credit facility indicator is information identifying the credit facility that the customer desires to utilize in making payment to the merchant. For example, the credit facility indicator is information that the customer wants to use a particular credit card to pay for a purchase. Alternatively, the credit facility indicator can be information that the customer wants to use a particular bank to facilitate the online purchase. Other types of credit facilities are envisioned within the scope of this disclosure.

Based on receiving the credit facility indicator, the merchant server determines a credit facility address at step 620. The credit facility address is information about an appropriate location to access the credit facility to request payment. For example, the credit facility address is a Uniform Resource Locator (URL) or other such network address. Alternatively, the address can be an IP address, a phone number or any other such information. In one embodiment, the credit facility address includes a port number at which the credit facility desires to receive inquiries related to a particular transaction.

The determined credit facility address is sent to the customer at step 630. The credit facility address can be sent via a network, such as the Internet, or via phone lines, email, postal service, or any other such transmission means.

FIG. 7 illustrates one embodiment of a method 700 for redirecting the customer to a credit facility in accordance with one aspect of the invention. Method 700 begins at step 710 by receiving a credit facility indicator from the customer. Based on the received credit facility indicator, the merchant server determines at least one credit facility address at step 720.

A customer credit transaction request is sent from the merchant server to the credit facility at step 730. A customer credit transaction request is a message from the merchant server indicating that a customer wishes to facilitate an online transaction with the merchant via the credit facility. The merchant server then receives a customer credit transaction request confirmation from the credit facility at step 740. A customer credit transaction request confirmation is a message indicating that the credit facility will serve to facilitate the online transaction between the customer and merchant.

Based on the customer credit transaction request confirmation, the merchant server then redirects communications from the customer to the credit facility and redirects communications from the credit facility to the customer at step 750. In one embodiment, the merchant server does not process communications except to determine their destination, such that the merchant server partially operates as a router. This redirection ends upon receipt at the merchant server of an indication that communications between the customer and credit facility have ended.

FIG. 8 illustrates one embodiment of a method 800 for facilitating online commerce between a merchant and a customer in accordance with one aspect of the invention. Method 800 begins at step 810 by receiving a request to pay at the merchant from the customer. In one embodiment, step 810 is implemented as in step 510.

Method 800 continues at step 820 by sending the customer a payment request based on the request to pay. The payment request includes a merchant ID indicative of the merchant. In one embodiment, the payment request further includes a digital signature associated with the merchant. Having sent the payment request to the customer, method 800 then redirects the customer to a credit facility at step 830. Redirecting the customer can be implemented in any appropriate fashion, including but not limited to, methods 600 and 700 illustrated in FIGS. 600 and 700.

At step 840, the merchant server receives a payment identifier from the customer. For example, the payment identifier can be a credit card number, debit card number, one time use credit card number, merchant based credit number, bank account, funds transfer record number, or the like. Based on receiving the payment identifier, the merchant sends the payment identifier to the credit facility. In one embodiment, the merchant sends the payment identifier and a merchant ID associated with the merchant. In one embodiment, the merchant receives payment based on the sent payment identifier. In another embodiment, the merchant then completes the online commerce with the customer. As used herein, the term “merchant based credit number” is any number determined based on the identity of a merchant or other third party to a customer/credit facility commercial relationship.

In another embodiment, the credit facility receives a payment identifier request from a customer. A payment identifier request is a request to receive a payment identifier from the credit facility for use in facilitating an online transaction by the customer with a merchant. Based on receiving the payment identifier request, the credit facility determines a credit card number associated with the customer. The credit card number can be a credit card number, bank account, or other such number indicative of a source of customer funds or credit.

Based on receiving the payment identifier request, the credit facility confirms the customer identity, such as with password, biometric data, or other such identity confirmation technique. Based on the identity confirmation and determined credit card number, the credit facility determines at least one payment identifier. The payment identifier can be, for example, a one time use number in the same format as a credit card issued by the credit facility. For example, if a particular credit facility issues credit cards, and the credit cards issued by the particular credit facility feature 16 digits, the payment identifier is a 16 digit number. In one embodiment, the credit identifier differs from each and every other credit identifier issued by the credit facility. In one embodiment, the payment identifier is valid for only a predetermined span of time, such as 24 hours, 7 days, or one year. Other time spans are envisioned. In one embodiment, the payment identifier is associated with at least one merchant. In such embodiments, the payment identifier will only be accepted by the credit facility if the associated merchant presents the payment identifier for payment.

Based on determining the payment identifier, the credit facility sends the payment identifier to the customer. The payment identifier is sent to the customer in any appropriate fashion, such as via a network such as the Internet, via telephone lines, email, postal service or the like. The credit facility receives the payment identifier from a merchant. Based on receiving the payment identifier from the merchant, the credit facility issues payment to the merchant. In one embodiment, the credit facility disables the payment identifier from further payments based on issuing payments to the merchant.

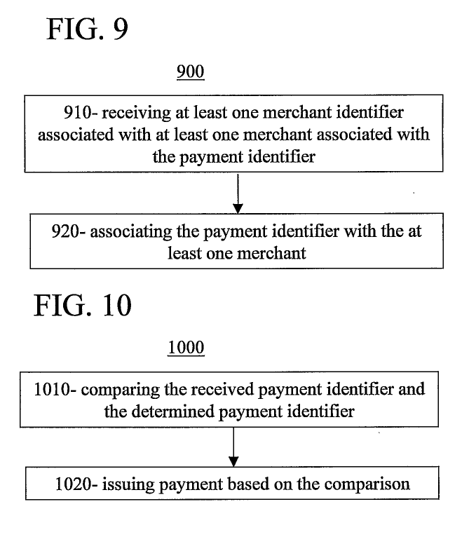

FIG. 9 illustrates one embodiment of a method 900 for determining a payment identifier in accordance with one aspect of the invention. Method 900 begins by receiving at least one merchant identifier associated with the payment identifier request at step 910. The merchant identifier is associated with a merchant. Method 900 then associates the determined payment identifier with the merchant associated with the merchant identifier at step 920. Associating the determined payment identifier includes encoding the merchant identifier in the payment identifier in one example.

FIG. 10 illustrates one embodiment of a method 1000 for issuing payment in accordance with one aspect of the invention. Method 1000 begins at step 1010 by comparing, at the credit facility, the received payment identifier and the determined payment identifier. Based on the comparison, the credit facility then issues payment to the merchant.

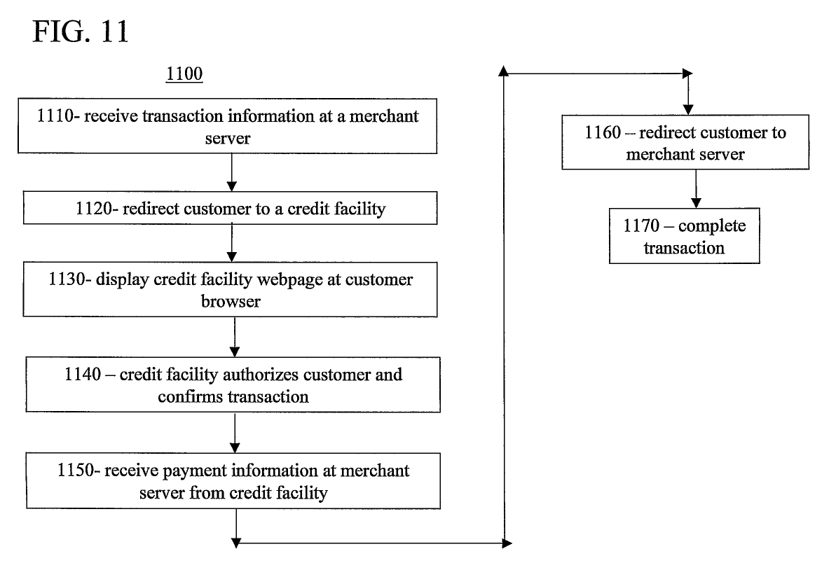

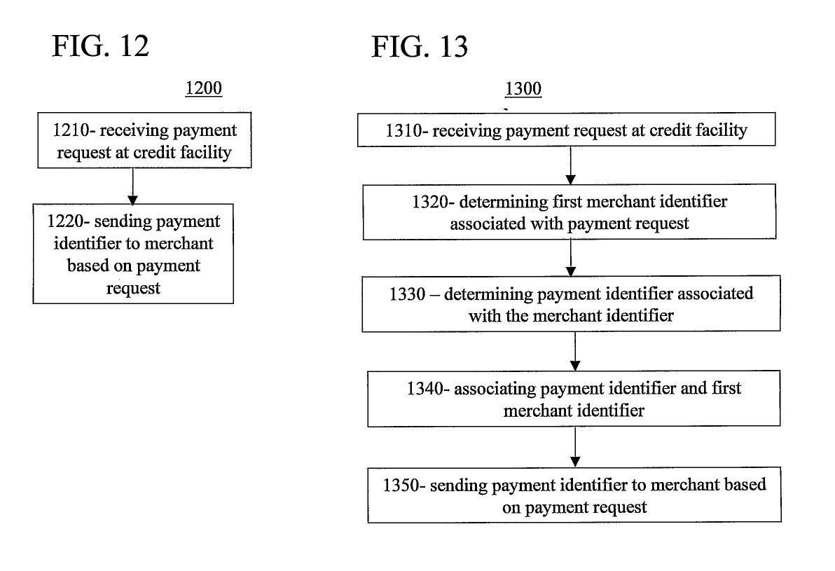

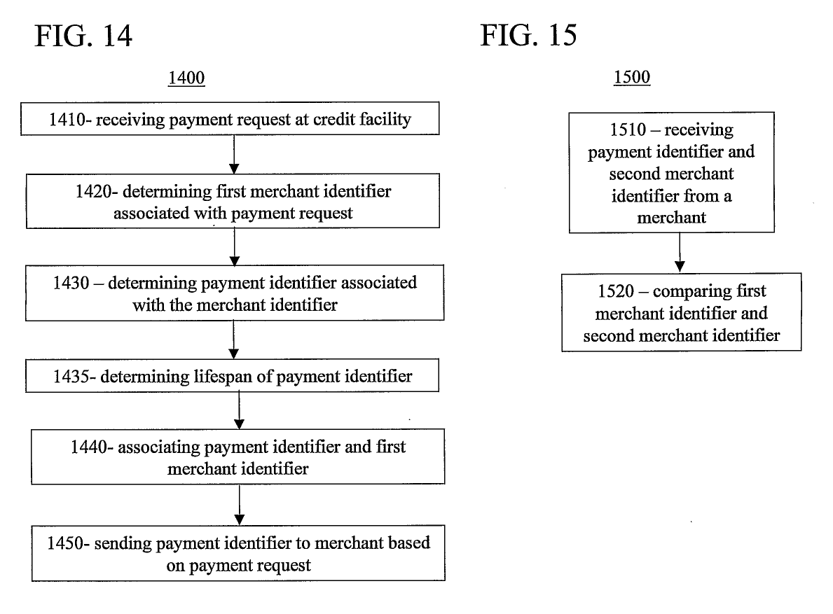

FIG. 11 illustrates one embodiment of a method 1100 for issuing payment in accordance with one aspect of the invention. Method 1100 begins at 1110 by receiving transaction information at a merchant server. For example, the transaction information can be a “check out” indication in a shopping cart. In addition, the transaction information can include information indicative of a desired credit facility for facilitating payments. For example, transaction information can include a check out button input and an indication that the customer wishes to transact commerce via VISA® credit facilities.

Based on the received transaction information, the merchant server redirects the customer to the credit facility at step 1120, and the credit facility web page is automatically displayed at the customer browser at step 1130. In one embodiment, redirecting the customer includes preparing a merchant request. A merchant request is a request for payment including merchant ID associated with the merchant server, a timestamp indicative of the current time, and other relevant information. In one embodiment, the merchant request includes the total charges to complete the online commerce.

The credit facility authorizes the customer and confirms the transaction at step 1140. Authorizing the customer and confirming the transaction can include use of user ids and passwords, biometric information, or similar security methods as well as the customer indicating assent to the transaction. In addition, the transaction is displayed at the merchant server, in one embodiment.

Based on authorization and confirmation, the credit facility creates a digital credit card and sends the digital credit card and payment information to the merchant server. The payment information is received at the merchant server from the credit facility at step 1150. Payment information includes appropriate data, such as the digital credit card, customer name, customer address, etc. The customer is then redirected from the credit facility back to the merchant server at step 1160, and the transaction is completed at step 1170.

In another exemplary implementation, a customer initiates an online transaction with a merchant server. The customer then is redirected to a credit facility, and receives a payment identifier from the credit facility. The payment identifier is associated with the merchant in one embodiment. In one embodiment, the credit facility confirms the customer's identity. The customer then provides the payment identifier to the merchant and receives the desired goods and/or services from the merchant responsive to the payment identifier.

FIG. 12 illustrates one example of a method 1200 for facilitating online commerce in accordance with one aspect of the invention. Method 1200 begins at 1210 by receiving a payment request at a credit facility. Based on receiving the payment request, the credit facility then sends a payment identifier to a merchant based on the payment request at step 1220. In another embodiment, the credit facility sends the payment identifier to the customer. The payment identifier can be a credit card number, one time use credit card number, merchant based credit number, or the like.

FIG. 13 illustrates one example of a method 1300 for facilitating online commerce in accordance with one aspect of the invention. Method 1300 begins at step 1310 by receiving a payment request at a credit facility. In one embodiment, step 1310 is implemented as in step 1210. The credit facility determines a first merchant identifier associated with the payment request at step 1320. Based on the first merchant identifier, the credit facility determines a payment identifier at step 1330. The payment identifier can be a one time use credit card number, or based on the merchant id. The payment identifier and first merchant identifier are associated at step 1340. The association can be stored at a database in communication with the credit facility. In another embodiment, the association is coded into the payment identifier, such as with encryption or steganographic coding.

At step 1350, the credit facility then sends the determined payment identifier to the merchant based on the payment request. In another embodiment, the determined payment identifier is sent to the customer. In one embodiment, step 1350 is implemented as in step 1220.

FIG. 14 illustrates one example of a method 1400 for facilitating online commerce in accordance with one aspect of the invention. Method 1400 begins at step 1410 by receiving a payment request at a credit facility. In one embodiment, step 1410 is implemented as in step 1210. The credit facility determines a first merchant identifier associated with the payment request at step 1420. Based on the first merchant identifier, the credit facility determines a payment identifier at step 1430. The payment identifier can be a one time use credit card number, or based on the merchant id.

In addition, at step 1435, method 1400 determines a lifespan of the payment identifier. The lifespan of a payment identifier is a measure of the validity of the payment identifier. For example, the lifespan can be measured in time, such as one day, one hour, one month, one year or other appropriate times. In another example, the lifespan is measured in usage, such as one use, two uses, or the like. In one embodiment, the lifespan determination is based on a user input, while in other embodiments, the lifespan is based on default values, based on the merchant id, or other such bases.

The payment identifier and first merchant identifier are associated at step 1440. The association can be stored at a database in communication with the credit facility. In another embodiment, the association is coded into the payment identifier, such as with encryption or steganographic coding.

At step 1450, the credit facility then sends the determined payment identifier to the merchant based on the payment request. In another embodiment, the determined payment identifier is sent to the customer. In one embodiment, step 1450 is implemented as in step 1220.

FIG. 15 illustrates one example of a method 1500 for facilitating online commerce in accordance with one aspect of the invention. Method 1500 begins at step 1510 by receiving a payment identifier and a second merchant identifier from a merchant. The second merchant identifier is data indicative of a merchant. The second merchant identifier may match with the first merchant identifier, but not necessarily. At step 1520, the first merchant identifier is compared with the second merchant identifier. In one embodiment, payment is conditioned on a valid comparison.

For example, the comparison can compare the merchant id to ensure that the payment identifier received with the second merchant identifier matches with the first merchant identifier to increase confidence that the payment identifier is legitimate and authorized by the customer. In the event that the merchant identifiers do not match, the credit facility can conclude that the payment identifier is not being used properly, or investigate further to ensure that the customer is authorizing use.

Payment identifiers disclosed herein can be implemented with a digital signature signed by appropriate entities. For example, the payment identifier can include a digital signature signed by the credit facility. In addition, the payment identifier can be encrypted using a key pair, such as a PKI key pair. Thus, for example, the payment identifier can include a digital signature signed by the credit facility using the private key of a PKI key pair. In another example, the payment identifier includes a digital signature signed by the credit facility using the public key of a PKI key pair.

In one embodiment, the digital signatures include a private key of a PKI key pair. In another embodiment, the payment identifier is encrypted by the credit facility with a public key of a merchant PKI key pair. In another embodiment, the payment identifier is encrypted with a PKI key pair algorithm and wherein the merchant maintains one of the key pair and the credit facility maintains the other of the key pair.

In embodiments featuring a merchant based credit number, those of skill in the art will recognize that the methods disclosed herein can be used to prevent a payment identifier from being used to purchase goods or services from merchants other than the merchant associated with the payment identifier. Thus, for example, if a payment identifier is associated with Merchant A, the credit facility can deny payment if Merchant B requests payment based on the payment identifier. In one embodiment, the credit facility can rank each of a plurality of merchants based on trust and refuse to issue merchant based credit numbers based on a trust rating. In another embodiment, the credit facility can rank each of a plurality of merchants based on history of credit transaction challenges, and refuse to issue merchant based credit numbers based on the rankings of history.

In another embodiment, a custom network protocol is used to transmit between the credit facility and merchant.

The methods disclosed herein can be implemented using computer program code on a computer readable medium for executing the method steps. Additionally, the software can be implemented using any appropriate combination of software and hardware. For example, the software can be implemented entirely with software, entirely with hardware, or any combination of software and hardware.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for facilitating online commerce, comprising:
receiving a payment request at a credit facility;
sending a payment identifier to a merchant based on the payment request.

2. The method of claim 1 wherein receiving a payment request includes receiving a customer network connection, and further comprising:
creating an account for the customer with the credit facility, if said account does not exist;
authenticating the customer at the credit facility;
retrieving a customer regular payment method based on customer identity; and
creating a payment identifier based on payment request and customer regular payment method.

3. The method of claim 1 wherein the payment identifier is one of a one time credit card, credit card, debit card, and electronic check.

4. The method of claim 1 wherein the payment identifier is a merchant based credit card, further comprising:
determining a first merchant identifier associated with the payment request;
determining a payment identifier associated with the merchant identifier; and
associating the payment identifier and first merchant identifier.

5. The method of claim 4, further comprising:
determining a life span of the payment identifier.

6. The method of claim 4, further comprising:
receiving a payment identifier and a second merchant identifier from a merchant; and
comparing the first merchant identifier and second merchant identifier.

7. A method for facilitating online commerce, the method comprising:
receiving a request to pay at a merchant server from a customer;
sending a payment request to a credit facility from the merchant server;
redirecting the customer to the credit facility based on the sending of the payment request; and
receiving a payment identifier at the merchant server from the credit facility.

8. The method of claim 7 wherein the payment identifier is one of a merchant based credit card, one time credit card, credit card, debit card, electronic check.

9. The method of claim 7 wherein redirecting the customer to a credit facility comprises:
receiving a credit facility indicator from the customer;
determining at least one credit facility address based on the received credit facility indicator; and
sending the credit facility address and redirection instructions to the customer.

10. The method of claim 7 wherein redirecting the customer to a credit facility comprises:
receiving a credit facility indicator from the customer;
determining at least one credit facility address based on the received credit facility indicator;
sending a customer credit payment request to the credit facility associated with the credit facility address based on the credit facility indicator; and
receiving a customer credit payment identifier from the credit facility based on the customer credit payment request.

11. A method for facilitating online commerce between a merchant and a customer, the method comprising:
receiving a request to pay at the merchant from the customer;
sending the customer a payment request based on the request to pay, the payment request including a merchant ID;
redirecting the customer to a credit facility;
receiving a payment identifier; and
transmitting the payment identifier to the credit facility.

12. The method of claim 11 wherein sending the payment request comprises creating the payment request, and wherein redirecting the customer includes redirecting the payment request, and wherein the payment identifier is received from the credit facility.

13. The method of claim 11 wherein the payment identifier includes a digital signature signed by the credit facility using the private key of PKI key pair.

14. The method of claim 11 wherein receiving a payment identifier request comprises receiving a redirected network connection from a customer and wherein transmitting the payment identifier to the customer comprises redirecting the customer to the merchant.

15. The method of claim 11 further comprising:
determining a credit transaction challenge history; and
determining the payment identifier based on the credit transaction challenge history.

16. The method of claim 11 further comprising:
determining a trust history; and
determining the payment identifier based on the trust history.
